(19) United States
(12) Patent Application Publication
(10) Pub. No.: US 2026/0044330 A1
(43) Pub. Date: Feb. 12, 2026

(54) NETWORK DEVICE, CONTROL METHOD, AND NON-TRANSITORY COMPUTER READABLE STORAGE MEDIUM

(71) Applicant: CANON KABUSHIKI KAISHA, Tokyo (JP)

(72) Inventor: YUKI SHIRAKAWA, Kanagawa (JP)

(21) Appl. No.: 19/291,154

(22) Filed: Aug. 5, 2025

(30) Foreign Application Priority Data
Aug. 9, 2024 (JP) 2024-133837

(51) Int. Cl. G06F 8/61; H04N 1/00

(52) U.S. Cl. CPC G06F 8/61; H04N 1/00411

(57) ABSTRACT

A network device includes a server configured to provide a user interface in response to a request from a terminal, one or more memories storing instructions, and one or more processors which, when executing the instructions, cause the network device to: provide, by using the server, a setting screen for setting a parameter used to install a Progressive Web Application corresponding to the network device, and transmit a manifest file corresponding to the parameter to a terminal to install the Progressive Web Application on the terminal.

### BACKGROUND

### Field of the Technology

This present disclosure relates to technology for sending notifications from network devices such as image processing devices to client devices.

### Description of the Related Art

Network devices such as image processing devices are able to display their operation status on their own displays. Examples of the operation status of the network devices include error occurrence situations, counter information, information regarding the consumption levels of consumables, and notices from administrators.

In addition, a network device provides functionality that enables client devices, which have accessed the network device through networks, to confirm the operation status of the network device, perform job operations, and configure various settings. This function is called the Remote User Interface (hereinafter referred to as “RUI”). Each network device is equipped with an internal web server and accesses the uniform resource locator (URL) of the RUI using a web browser of an external device, for example, to provide a display of the RUI. The RUI is often used within local area networks (LANs) and can be accessed by entering the private Internet protocol (IP) address assigned to the network device as a URL from a web browser on a terminal (PC or tablet).

Japanese Patent Laid-Open No. 2009-271727 describes technology for improving accessibility to RUIs by enabling image processing devices themselves to automatically generate shortcut icons to eliminate the need to enter IP addresses to access the RUIs.

Additionally, Progressive Web Application (app) (hereinafter referred to as “PWA”) is technology that enables websites to be used as if they were native applications. In this case, a traditional native application is an application that a user can use after the user themselves operates an information processing device, downloads the application from an application store to the information processing device, and installs the application. In contrast, a PWA can be installed by accessing a PWA-enabled website via a web browser on an information processing device and is a technology that makes it possible to use the website (web application) on the information processing apparatus with an operation experience similar to that of a native application.

### SUMMARY

A network device equipped with a server includes a provision unit configured to use the server to provide a setting screen for setting a parameter used to install a Progressive Web Application corresponding to the network device, and a transmission unit configured to transmit a manifest file corresponding to the parameter to a terminal to install the Progressive Web Application on the terminal.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of the configuration of a network system.

FIGS. 2A and 2B are hardware configuration diagrams.

FIG. 3 is a software configuration diagram.

FIG. 4 is a diagram illustrating an example screen of a Remote User Interface (RUI).

FIG. 5 is an installation sequence diagram of a Progressive Web Application (PWA).

FIG. 6 is a diagram illustrating an example screen of the RUI when the PWA is installed.

FIG. 7 is a diagram illustrating an example screen when the RUI is launched as a PWA.

FIG. 8 is a diagram illustrating an example screen displaying icons generated after PWA installation.

FIG. 9 is a diagram illustrating a PWA installation sequence.

FIG. 10 is a diagram illustrating an example screen displaying a PWA installation URL generation page.

FIG. 11 is a diagram illustrating an example screen displaying icons generated after PWA installation.

FIG. 12 is a diagram illustrating an example screen displaying a page through which PWA icon settings are configured through the RUI.

FIG. 13 is a diagram illustrating an example screen in a case where a PWA installation URL generation page is accessed in a state where PWA icon settings have been configured.

### DESCRIPTION OF THE EMBODIMENTS

In the present embodiment, a network device has a mechanism that provides a combination of two technologies: a Remote User Interface (RUI) and a Progressive Web Application (PWA).

For example, by accessing the RUI of a network device using a web browser, it is possible to download and install a PWA that supports the provision of at least one or some of the functions of the network device on an information processing device on which the web browser is running. In this case, as the functions supported by the PWA, it is possible to provide at least one or some of the functions of the RUI serving as a web application.

In addition, an icon displayed on the information processing device for the PWA installed on the information processing device depends on information preset on the website that provides the PWA. For example, the icon is generated based on a name and an image that directly indicate, for example, the model of the network device and the type of firmware.

In this case, it is assumed that users who primarily use the RUI are users with administrator privileges (administrators) who manage network devices. Such an administrator may manage multiple network devices by themselves in an office or a similar environment. In the office, multiple network devices of the same model may be installed on the office network. Under such a management environment, when the administrator attempts to manage the devices using PWAs, multiple icons that look similar or identical will be generated for multiple PWAs corresponding to multiple different network devices and displayed on the administrator's information processing device. Thus, it is often difficult for the administrator to distinguish between the network devices by their icons, thereby leaving room for improvement in operability.

In the following, the present embodiment will describe, using the drawings and other information, examples in which the above-described operability of the RUI provided by an image processing device serving as a network device and a corresponding PWA is improved.

### First Embodiment

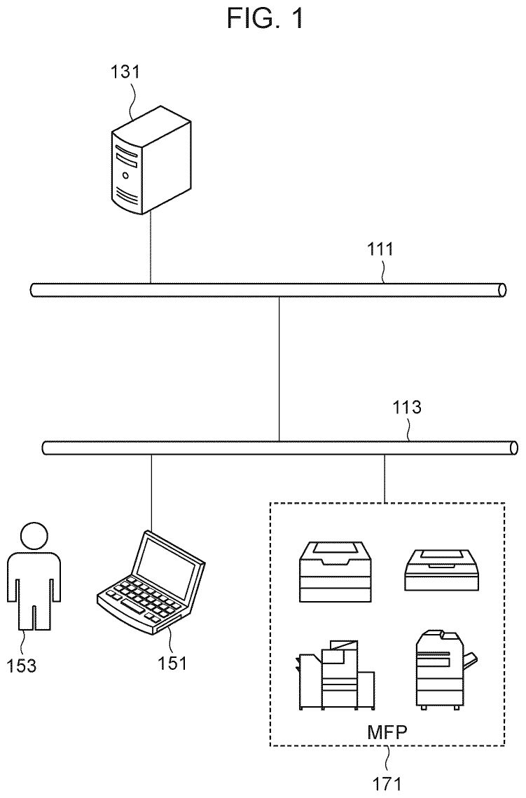

FIG. 1 is a diagram illustrating an example of the configuration of a network system. In FIG. 1, a push server 131, a terminal 151, and multifunction peripherals (MFPs) 171 are connected to each other through networks 111 and 113. The networks 111 and 113 are so-called communication networks, such as the Internet, which is realized, for example, by LANs, WANs, telephone lines, dedicated digital lines, Asynchronous Transfer Mode (ATM) lines, Frame Relay lines, cable television lines, and wireless lines for data broadcasting. It is sufficient that the networks 111 and 113 enable data transmission and reception. In the present disclosure, the network 111 is the Internet, and the network 113 is, for example, the Internet or a wired-wireless LAN set up on a network within a typical home or office.

The push server 131 is a server computer that communicates with the terminal 151 and the MFPs 171. Alternatively, the push server 131 can be built employing cloud computing technology, for example. The functions of the push server 131 may be realized by a single server or a single virtual server or by multiple servers or multiple virtual servers. Alternatively, multiple virtual servers may be run on a single server. Note that the push server 131 is a server necessary to realize a push notification function, which is one of PWA functions.

The terminal 151 is an example of an information processing device used by a user such as an administrator. Specifically, the terminal 151 is a device capable of running a web browser, such as a personal computer (PC), a laptop, a smartphone, or a tablet. The terminal 151 may be a mobile terminal having an internal environment in which various programs, such as a general-purpose operating system (OS), can run.

The terminal 151 has the function of receiving notification messages from the push server 131, displaying the RUIs provided by the MFPs 171, and accepting operations from a user 153 to transmit and receive data to and from individual information processing devices. The user 153 uses a management system according to the present embodiment to manage device setting information regarding the MFPs 171 or monitors the status of the MFPs 171.

The MFPs 171 are examples of image processing devices serving as network devices. The illustrated MFPs 171 are multifunction peripheral devices and are, for example, image processing devices having at least one or some of multiple functions such as a scanning function, a printing function, a faxing function, and a communication function. Other examples of network devices to which this embodiment can be applied include devices equipped with a web server and capable of providing an RUI, such as network routers, surveillance cameras, and digital medical devices.

Each MFP 171 has functionality that provides an RUI in response to a request from the terminal 151, and the RUI can be accessed through an application, such as a web browser, of the terminal 151. The MFP 171 detects its device status and events (for example, part replacement and internal device error alerts), stores them as its device information inside the MFP 171, and can provide the terminal 151 with these various types of device information through the RUI. The MFP 171 has functionality that transmits the aforementioned various types of device information to external management servers, which can then manage the MFP 171 by receiving and processing the various types of device information transmitted from the MFP 171. Furthermore, by using the push server 131, the MFP 171 can send a push notification to the terminal 151 used by the user 153 in accordance with pre-set rules when an event occurs internally.

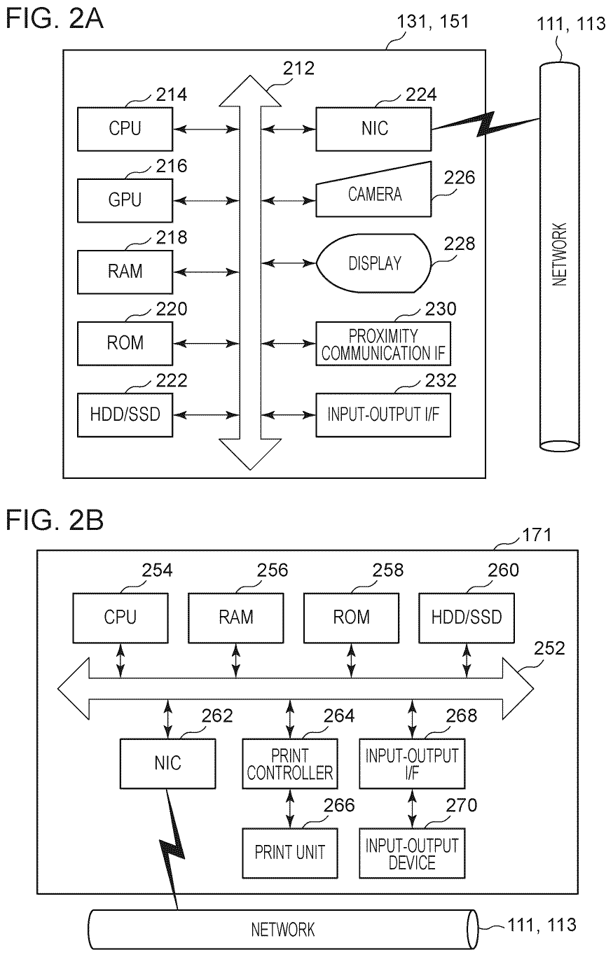

FIGS. 2A and 2B are diagrams illustrating examples of the hardware configurations of information processing devices such as the push server 131, the terminal 151, and each MFP 171.

FIG. 2A is a diagram illustrating the hardware configuration of the push server 131 and that of the terminal 151.

A system bus 212 manages the flow of data within the device. A central processing unit (CPU) 214 controls the entire device. The CPU 214 executes, for example, application programs and the OS stored in a hard disk drive (HDD)/solid state drive (SSD) 222 and performs control to store, in a random-access memory (RAM) 218, information necessary to execute the programs, files, and other information. A graphics processing unit (GPU) 216 performs arithmetic processing necessary mainly for displaying images and videos. The RAM 218 is a temporary storage unit and serves as a primary memory, a work area, and so forth for the CPU 214 and GPU 216. A read-only memory (ROM) 220 is a storage unit and stores various types of data, such as a basic I/O program, inside. The HDD/SSD 222 is a type of external storage unit. The HDD/SSD 222 serves as a large memory and stores application programs, such as a web browser, programs for a service server group, an OS, and related programs, for example. A network interface card (NIC) 224 exchanges data with external devices via the NIC 224 and the networks 111 and 113. A camera 226 is located at the terminal 151 and includes a rear camera that captures images of the surrounding area and a front camera that captures images of the user themselves. By analyzing a two-dimensional code captured by the camera 226 using an application program stored in the HDD/SSD 222, it is possible to access a website or launch a specific application. A display 228 is a display unit that displays, for example, information necessary to operate UIs provided by external web servers and the MFPs 171. Moreover, the display 228 may be a device that has the function of accepting operation commands from the user, such as a touch panel. A proximity communication interface (I/F) 230 is an I/F for proximity communication, such as NFC and Bluetooth. Using the proximity communication I/F 230 enables data exchange between the information processing devices. An input-output I/F 232 is an interface for controlling input and output to and from external devices and controls, for example, input-output devices, such as a mouse and keyboard connected to the input-output I/F 232.

FIG. 2B is a diagram illustrating a hardware configuration of the MFP 171 and illustrates an image processing device as an example. A CPU 254 reads programs stored in a ROM 258 and comprehensively controls the entire device through an internal bus 252. A RAM 256 serves as a memory or work area for the CPU 254. An HDD/SSD 260 is a storage device that stores various types of data. A NIC 262 exchanges data with external network devices either unidirectionally or bidirectionally. A print controller 264 is a controller that controls a print unit 266 and issues print commands to the print unit 266 based on various control commands for the MFP 171. The print unit 266 executes printing based on a command from the print controller 264. An input-output device 270 indicates multiple components responsible for input and output to and from the MFP 171. Specifically, an input from a user (button input, etc.) is accepted, and the signal corresponding to the input is transmitted to each of the aforementioned processing units through an input-output I/F 268. In addition, the input-output device 270 also includes a display device (such as a touch panel) for providing necessary information to the user and accepting user operations. Furthermore, the input-output device 270 also includes a scanning device for reading documents and accepting them as electronic data, as well as sensors for detecting the remaining quantity and replacement of parts and consumables.

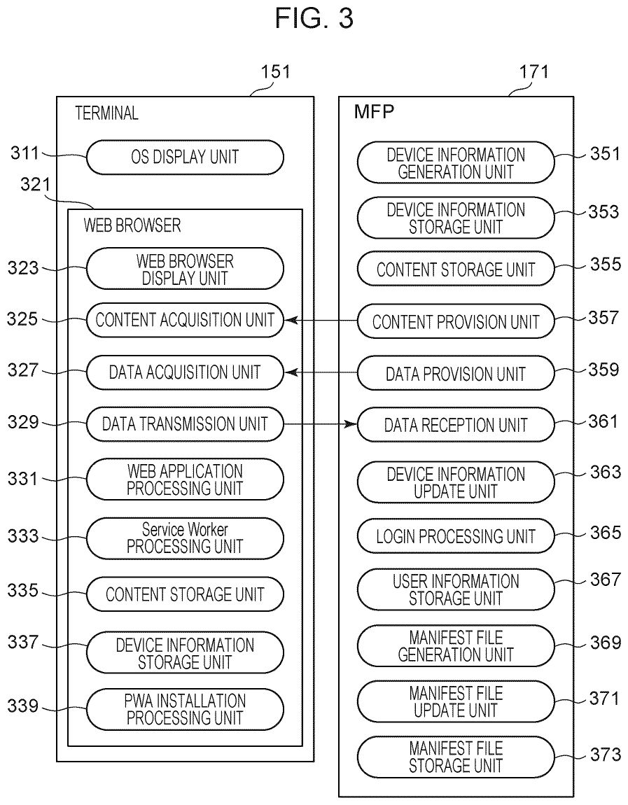

Note that the aforementioned configurations of the information processing devices are an example and are not limited to the example configurations illustrated in FIGS. 2A and 2B. For example, the storage location of data and programs can be changed among the RAMs, ROMs, HDDs/SSDs, and so forth as illustrated in FIGS. 2A and 2B, depending on the characteristics of the data and programs. In addition, each CPU and each GPU described in FIGS. 2A and 2B executes processing based on the programs stored in the corresponding HDD/SSD, thereby realizing processing in a software configuration as illustrated in FIG. 3.

FIG. 3 illustrates a software configuration including selected functions that are related to the present embodiment within the terminal 151 and MFP 171.

The terminal 151 includes an OS display unit 311 and a web browser 321. The web browser 321 includes, as internal software modules, a web browser display unit 323, a content acquisition unit 325, a data acquisition unit 327, a data transmission unit 329, and a web application processing unit 331. The web browser 321 further includes a Service Worker processing unit 333, a content storage unit 335, a device information storage unit 337, and a PWA installation processing unit 339.

The OS display unit 311 is a software module that displays functions provided by the OS as a graphical user interface (GUI) on the display 228. When the user 153 operates the terminal 151 through the GUI or after a PWA, which is described below, is installed, the OS display unit 311 has a function necessary to display the corresponding PWA icon added to the desktop, a folder, home screen, or the like.

Next, each software module of the web browser 321 will be described. The web browser display unit 323 is a software module that displays the RUI, which is provided by the MFP 171, on the display 228. In the present embodiment, a description will be made in which each MFP 171 is equipped with a web server, the RUI provided by the MFP 171 is provided as a web application, and the RUI is displayed on the web browser display unit 323.

The content acquisition unit 325 is a software module that acquires, from a content provision unit 357, web content necessary for displaying the RUI on the web browser display unit 323. Examples of the web content are based on Hypertext Markup Language (HTML), Java Script, and Cascading Style Sheets (CSS). In addition, the examples of the web content include Service Worker (a script that runs as a background process) and a manifest file (a file in which PWA installation settings are described), which are components of a PWA.

The data acquisition unit 327 is a software module that communicates with a data provision unit 359 to acquire device information such as setting values within the MFP 171. The data acquired by the data acquisition unit 327 and the aforementioned web content are combined and displayed on the web browser display unit 323 to realize the RUI. The data acquisition unit 327 can also realize an RUI in which display content dynamically changes by acquiring data from the data provision unit 359 in an asynchronous manner relative to the operation performed by the user 153. The data transmission unit 329 is a software module that transmits setting values to be applied to the MFP 171 and input values and files from the user 153 to a data reception unit 361 and transmits a user ID and a password for logging in to the RUI.

The web application processing unit 331 is a software module that analyzes various types of web content and data acquired from the MFP 171 and that comprehensively controls the behavior of web applications running on the web browser 321.

The Service Worker processing unit 333 is a software module that registers, in the web browser 321, Service Worker acquired by the content acquisition unit 325 and runs Service Worker in the background. Since Service Worker operates in the background, functions can be realized such as improved RUI display speed through cache control, offline operation, background synchronization, and push notifications.

The content storage unit 335 is a storage region and a storage module within the web browser 321 for storing various types of web content acquired by the content acquisition unit 325. In particular, the Service Worker processing unit 333 stores registration information regarding Service Worker in the content storage unit 335 and stores various types of web content in the content storage unit 335 when performing cache control.

The device information storage unit 337 is a storage region and storage module within the web browser 321 for storing, for example, the device information regarding the MFP 171 acquired by the data acquisition unit 327 and is stored in a storage region, such as Local Storage. By storing the device information in the device information storage unit 337, improved RUI display speed can be expected similar to the cache of the web content. In addition, reference to the device information regarding the MFP 171 can be made even when the MFP 171 is offline, and setting values to be applied to the MFP 171 can be input in advance.

The PWA installation processing unit 339 is a software module that performs processing related to PWA installment. PWA installation methods and installation sequences will be described below.

The MFP 171 includes a device information generation unit 351, a device information storage unit 353, a content storage unit 355, the content provision unit 357, the data provision unit 359, the data reception unit 361, a device information update unit 363, a login processing unit 365, and a user information storage unit 367. Furthermore, the MFP 171 includes a manifest file generation unit 369, a manifest file update unit 371, and a manifest file storage unit 373, which are features of the present disclosure.

The device information generation unit 351 is a software module that generates device information, such as the latest status and setting values within the MFP 171. The device information storage unit 353 is a software module that stores the status generated by the device information generation unit 351 and device information, such as setting values within the MFP 171, updated by the device information update unit 363 to be described below. The content provision unit 357 is a software module that provides various types of web content that form the RUI in response to a request from the content acquisition unit 325.

The data provision unit 359 is a software module that provides data, such as the device information and setting values regarding the MFP 171, in response to a request from the data acquisition unit 327. The data reception unit 361 is a software module that receives requests transmitted from the data transmission unit 329.

The device information update unit 363 is a software module that performs an update to obtain the latest device information in response to, for example, a change request for the device information generated by the device information generation unit 351 and the setting values received by the data reception unit 361. The device information update unit 363 stores the updated device information into the device information storage unit 353. The login processing unit 365 is a software module that accepts, from the data transmission unit 329, a login request for the RUI through the data reception unit 361 and compares the accepted data with the user's account information stored in the user information storage unit 367 to determine whether or not to allow login. The user information storage unit 367 is a software module that stores account information regarding users who use the RUI.

Table 1 below illustrates an example of data managed by the user information storage unit 367.

TABLE 1

| User ID | Password | Role |
|---|---|---|
| userA | ********** | administrator |
| userB | ********** | maintainer |
| userC | ********** | viewer |

A user ID column corresponds to IDs that uniquely identify users. A password column corresponds to basic authentication passwords used to log in with user IDs. The login processing unit 365 compares the combination of a user ID and a password included in the login request from the data transmission unit 329 with Table 1. If they match, the login processing unit 365 returns a login result indicating success to the data transmission unit 329. A role column indicates the users' permission levels. For example, if a user is an “administrator”, the user can use all RUI functions. If a user is a “maintainer”, the user can only use the functions related to the maintenance of the MFP 171. If a user is a “viewer”, the user can only view the device information. These attributes are used to implement such access control. When accessing the RUI, whether login processing is required can be switched by the settings of the MFP 171. If login is not required, that is, if all users within the LAN are allowed to use the RUI, access control is not performed.

The manifest file generation unit 369 is a software module that generates a manifest file in which PWA installation settings are described. The manifest file update unit 371 is a software module that performs an update process on a manifest file in a case where the manifest file is to be updated in response to a command from the user 153. The manifest file storage unit 373 is a software module that stores manifest files generated and updated by the manifest file generation unit 369 and the manifest file update unit 371. The operation of the manifest file generation unit 369 and that of the manifest file update unit 371, which are features of the present disclosure, will be described below.

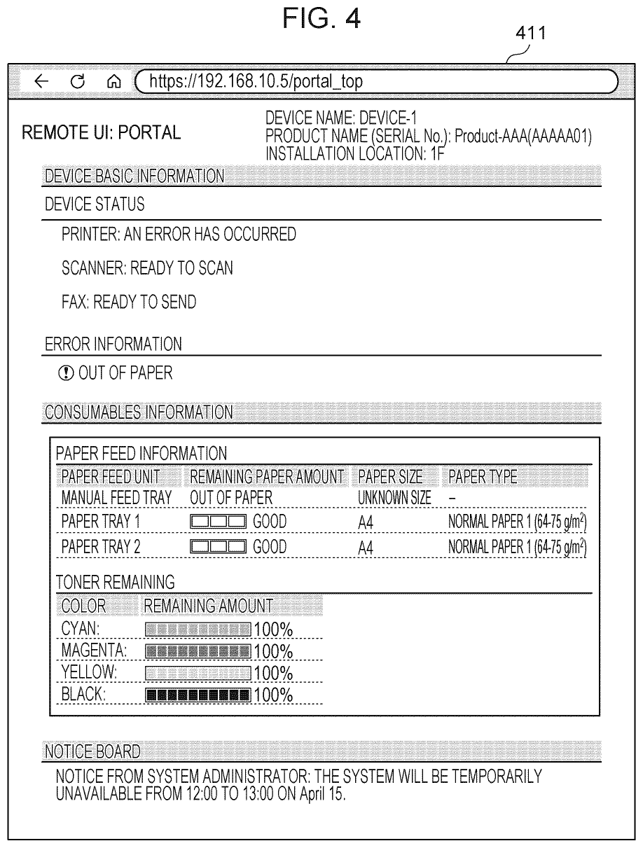

FIG. 4 is a diagram illustrating an example screen of an RUI provided by a typical MFP. A screen 411 illustrates a screen of the RUI displayed on the web browser display unit 323.

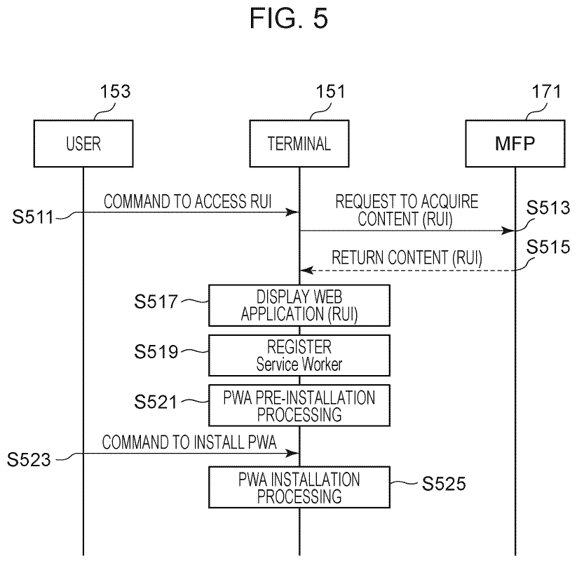

Next, FIGS. 5 to 8 are used to describe an example of a processing sequence for installing the RUI provided by the MFP 171 as a PWA on the terminal 151 and an example screen on the web browser display unit 323.

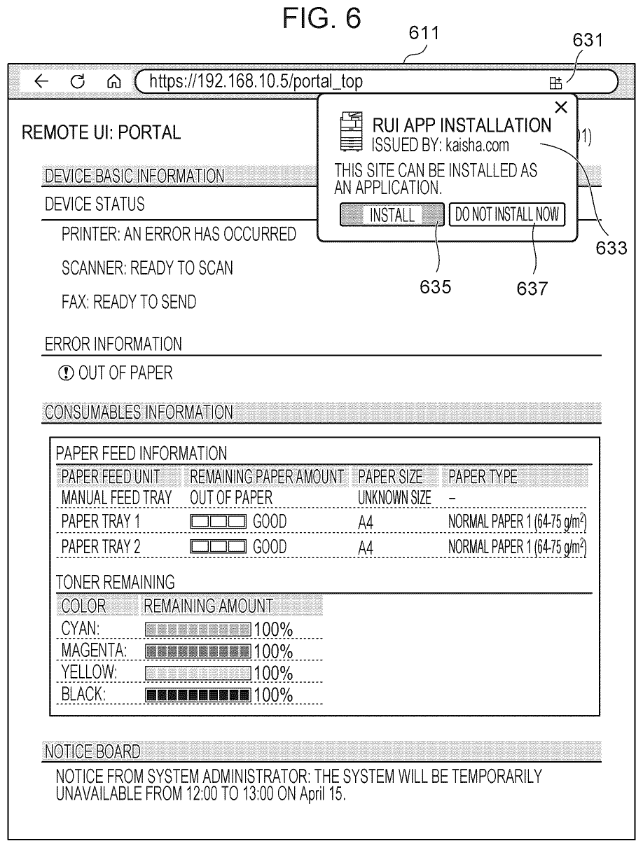

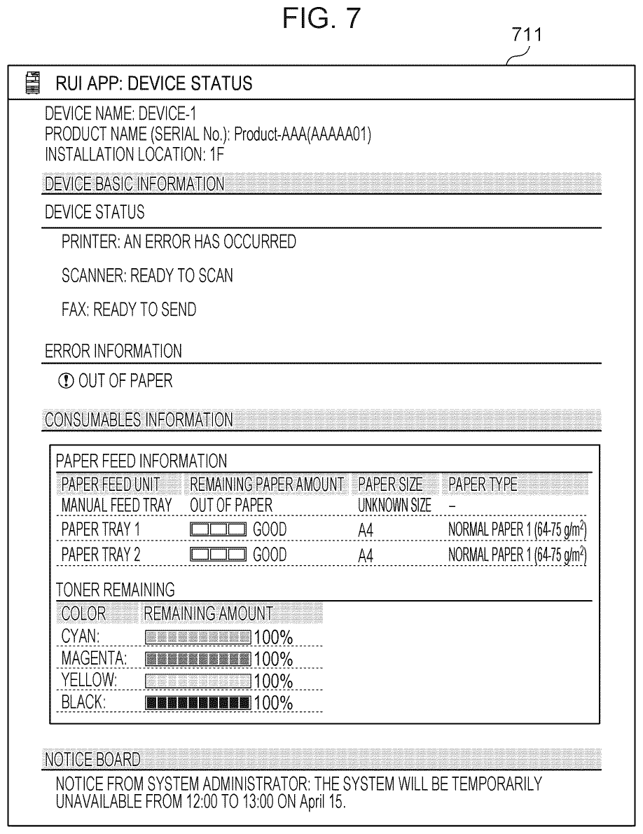

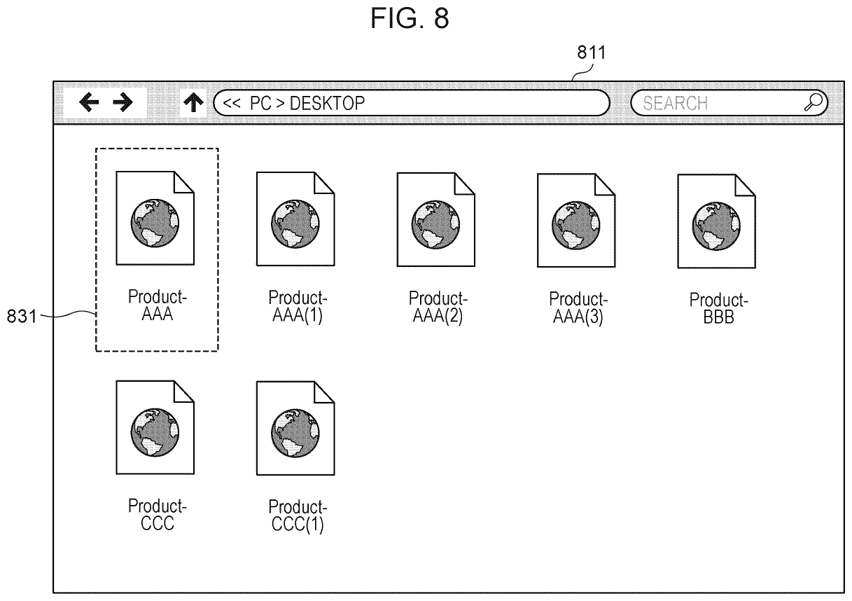

FIG. 5 is a diagram illustrating the sequence from when the user 153 commands the terminal 151 to access the RUI of the MFP 171 to when a corresponding PWA is installed. FIG. 6 is a diagram illustrating an example screen on the web browser display unit 323 when the PWA is installed. FIG. 7 is a diagram illustrating an example screen on the web browser display unit 323 when the RUI is displayed as the PWA. FIG. 8 is a diagram illustrating an example screen displaying icons displayed on the OS display unit 311 after installation of the PWA.

First, in S511, the user 153 commands the web browser 321 of the terminal 151 to access the RUI of the MFP 171. Specifically, the user 153 accesses the RUI of the MFP 171 by entering the IP address assigned to the MFP 171 into the address bar of the web browser 321.

In S513, the content acquisition unit 325 requests web content, which is for displaying the RUI on the web browser display unit 323, from the content provision unit 357. In S515, the content provision unit 357 returns the requested web content to the content acquisition unit 325. In S517, the web application processing unit 331 analyzes the details of the web content acquired in S515 and performs processing to display the RUI on the web browser display unit 323.

In S519, the Service Worker processing unit 333 analyzes a Service Worker script included in the web content acquired in S515 and registers Service Worker in the content storage unit 335. In this case, in a case where a command related to cache control is described in the Service Worker script, the Service Worker processing unit 333 stores the web content acquired in S515 as a cache in the content storage unit 335 in accordance with the described information.

In S521, the PWA installation processing unit 339 performs pre-installation processing to check whether the web content acquired in S515 includes a manifest file. In a case where it is determined that a manifest file is included, the PWA installation processing unit 339 performs processing so that various types of object as illustrated in FIG. 6 are displayed on the web browser display unit 323. Note that it is assumed in this case that a manifest file is transmitted from the MFP 171 to the terminal 151 as part of the web content; however, a manifest file may be transmitted separately from the web content from the MFP 171 to the terminal 151.

A screen 611 in FIG. 6 illustrates an example screen on the web browser display unit 323 at the time when the processing in S521 is performed. A button 631 is a button displayed in a case where the web application being viewed can be installed as a PWA. A notification object denoted by 633 is displayed when the user 153 presses the button 631. A button 635 is a button the user 153 presses when they choose to install the PWA.

A button 637 is a button the user 153 presses when they choose not to install the PWA. In this case, a case will be described in which the user 153 presses the button 635 to start installation of the PWA (execute S523).

In S523, the PWA installation processing unit 339 accepts a PWA installation command based on the user 153 pressing the button 635, and the process proceeds to processing in S525. In S525, the PWA installation processing unit 339 performs PWA installation processing. The following describes a manifest file that the PWA installation processing unit 339 uses to perform the PWA installation processing.

The following is an example of a manifest file (JSON format).

```
{
  “name”:“Product-AAA”,
  “short_name”:“proAAA”,
  “start_url”:“/”,
  “lang”:“ja-jp”,
  “display”:“standalone”,
  “background_color”:“#fff”,
  “theme_color”:“#e88c31”,
  “description”:“Remote User Interface (Product-AAA)”,
  “scope”:“/”,
  “orientation”:“any”,
  “icons”:[
    {
      “src”:“/default512.png”,
      “sizes”:“512x512”,
      “type”:“image/png”
    }
  ]
}
```

There are other keys that can be specified in addition to those described in the above example. The following describes a “name” key, a “short_name” key, and an “icons” key related to the features of the present embodiment.

The value of the “name” key specifies a name (application name) to be assigned to an icon generated when the PWA is installed by the PWA installation processing unit 339.

Similar to the “name” key, the “short_name” key is a key for specifying the name of the icon generated when the PWA is installed by the PWA installation processing unit 339.

However, the PWA installation processing unit 339 determines which value to use, the “name” key or the “short_name” key, in accordance with the type of the terminal 151. For example, in a case where the terminal 151 is a terminal with the display 228 that is relatively large, such as a PC, the value of the “name” key is used. In a case where the terminal 151 is a terminal with the display 228 that is small, such as a smartphone, the value of the “short_name” key is used. That is, generally, the normal application name is specified in the “name” key, and the shortened application name is specified in the “short_name” key.

The value of the “icons” key specifies an image file name used as an image of the icon generated when the PWA is installed by the PWA installation processing unit 339. An “src” key within the “icons” key specifies the URL where an image file to be used as the image of the icon is located, and the URL is specified using a relative path in the above-described example. A “sizes” key specifies the dimensions of the image. A “type” key specifies the Multipurpose Internet Mail Extensions (MIME) type of the image. The value for the “icons” key is an array, allowing multiple values to be specified. Thus, in the same manner for the “name” key and the “short_name” key, the PWA installation processing unit 339 uses an image of an appropriate size in accordance with the type of the terminal 151.

In the present embodiment, the example of the manifest file described above is a default manifest file set in the MFP 171. The manifest file is assumed to be similar to that of another MFP 171 if the device types or firmware versions of the MFPs 171 are the same. In S525, when the PWA installation processing unit 339 performs the PWA installation processing, a profile for executing various types of web content that constitute the RUI of the MFP 171 is installed on the web browser 321. Simultaneously, in accordance with the information described in the above-described manifest file, an icon for launching the PWA is generated on the OS display unit 311 (desktop, home screen, etc.). In this manner, as a result of the PWA installation processing unit 339 performing the PWA installation processing, the user 153 can use the RUI of the MFP 171 as a PWA.

Note that the PWA operates as a process of the web browser 321, and thus the actual PWA icon generated at the time of installation is assumed to be, for example, a shortcut icon that specifies the executable file and startup options for launching the web browser 321. However, since the implementation method for functions related to the PWA depends on the implementation of the web browser, the implementation method for functions related to the PWA is not necessarily limited to this implementation method. The user 153 can launch the PWA corresponding to the RUI of the MFP 171 by pressing the icon generated by the PWA installation processing unit 339.

A screen 711 in FIG. 7 is an example screen of an application (RUI application) provided in a case where the user 153 launches the installed PWA. The web content displayed on the screen 711 is equivalent to that displayed on the screen 411, but differs from the display of a normal web browser in that the screen 711 does not have an address bar, for example. This provides a user experience similar to that of a native application.

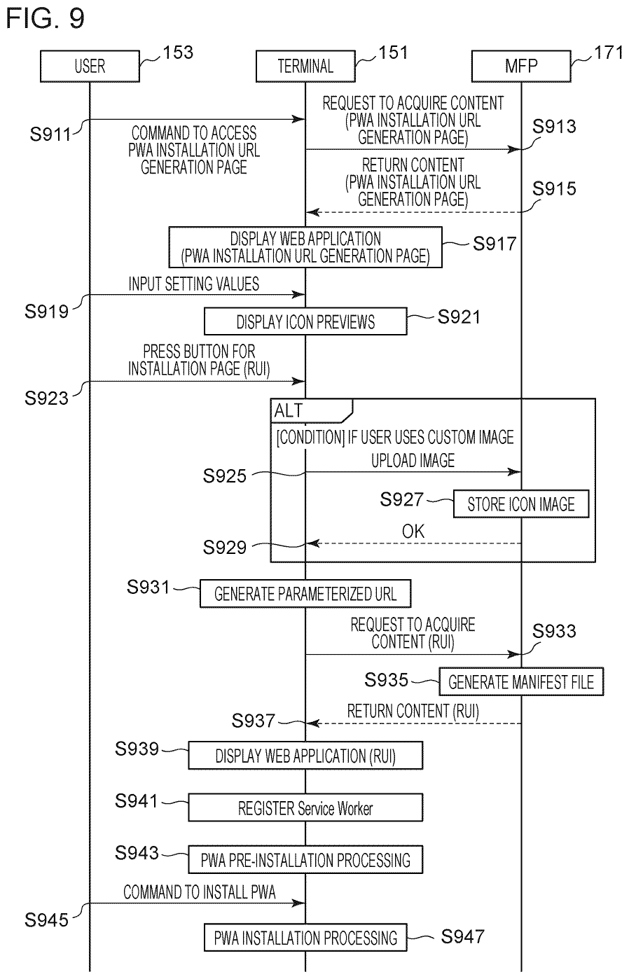

Reference is made to FIG. 8. A screen 811 is an example screen on the OS display unit 311 after the PWA installation processing unit 339 installs a PWA. The screen 811 displays icons of files located at certain paths within the file system. An icon 831 is an icon for launching a PWA corresponding to the RUI of the MFP 171. The group of icons displayed on the screen 811 are an example of displayed icons that are generated when the RUIs of multiple MFPs 171 are installed as PWAs on a single terminal 151. In this case, manifest files are not set so that the MFPs 171 can be distinguished from each other, and thus the PWA installation processing unit 339 generates icons with similar images and names. Thus, it is difficult for the user 153 to grasp the correspondence between the icons and the PWAs corresponding to the RUIs of the MFPs 171. To solve this problem, a PWA installation method according to the present disclosure is described using FIGS. 9, 10, and 11.

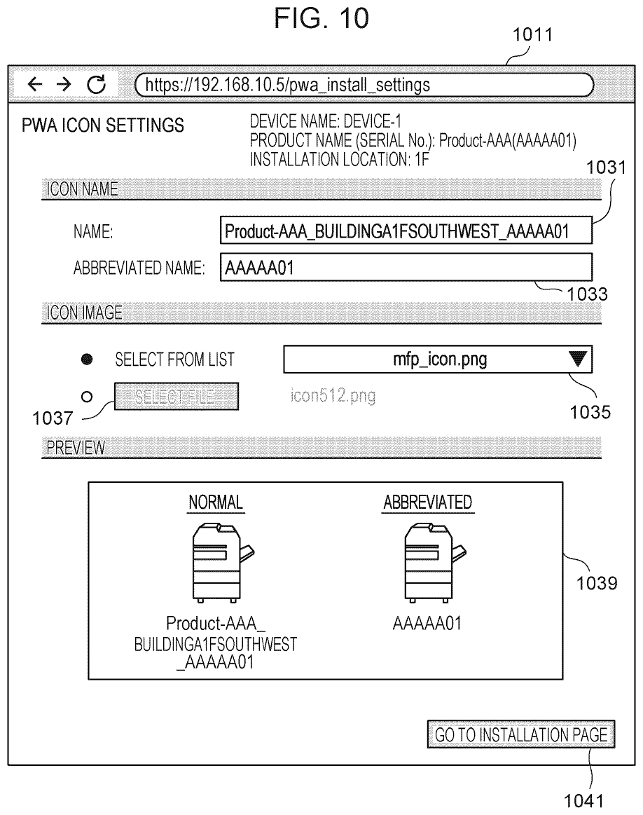

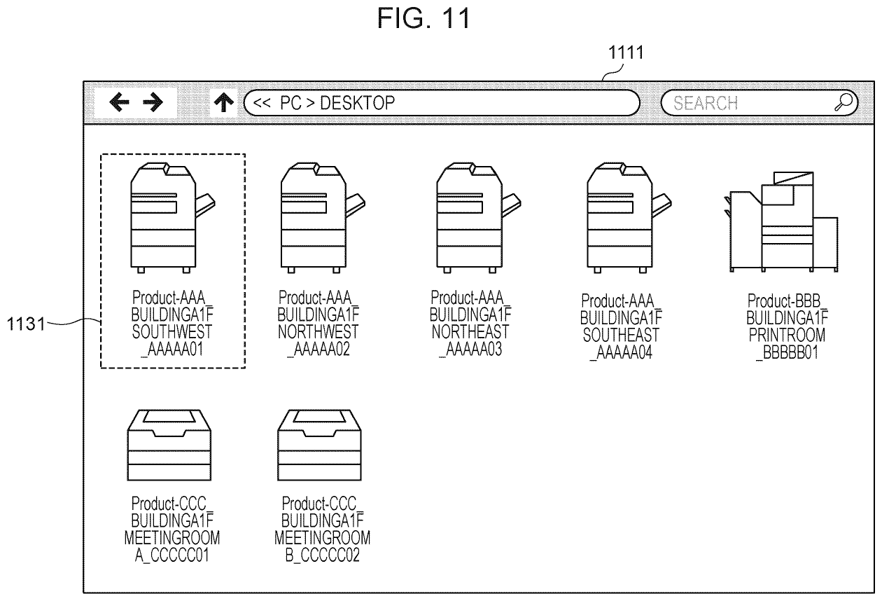

FIG. 9 is a diagram illustrating the sequence up to installation in the present embodiment. FIG. 10 illustrates a setting screen (hereinafter referred to as “PWA installation URL generation page”) provided by the MFP 171. Through the setting screen, settings related to icons of a PWA are set before installation of the PWA into a terminal. FIG. 11 is a diagram illustrating an example screen displaying icons that are generated by the PWA installation processing unit 339 after installation of the PWA.

In S911, the web browser 321 of the terminal 151 accepts a command to access a PWA installation URL generation page of the MFP 171 from the user 153. Specifically, the user 153 enters the URL of the PWA installation URL generation page into the address bar of the web browser 321 to access a web page provided by the MFP 171 that is different from the normal RUI illustrated in FIG. 4. An example screen displaying the PWA installation URL generation page and its behavior as a web page will be described below.

In S913, the content acquisition unit 325 requests web content, which is for displaying the PWA installation URL generation page on the web browser display unit 323, from the content provision unit 357. In S915, the content provision unit 357 returns the requested web content to the content acquisition unit 325.

In S917, the web application processing unit 331 analyzes the details of the web content acquired in S915 and performs processing to display the PWA installation URL generation page on the web browser display unit 323.

In the following, the PWA installation URL generation page will be described using FIG. 10. A screen 1011 is a screen in a state where the PWA installation URL generation page is displayed on the web browser display unit 323. In the present embodiment, a manifest file is dynamically generated in accordance with values input into this PWA installation URL generation page and is returned to the content acquisition unit 325, so that the PWA installation processing unit 339 controls the icons generated when the PWA is installed.

An input field 1031 is a field for specifying an icon name and receives a value to be set in the “name” key of the manifest file. An input field 1033 is a field for specifying an abbreviated icon name and receives a value to be set in the “short_name” key of the manifest file. Note that setting values, such as a device name and installation location set through the RUI of the MFP 171, may be input into the input fields 1031 and 1033 as default values. A pulldown menu 1035 is a pulldown menu for selecting an image to be used for the icons, and the selected image is set in the “icons” key of the manifest file. Images that can be selected using the pulldown menu 1035 are images prestored in the content storage unit 355 of the MFP 171. A button 1037 is a button for selecting an image to be used for the icons, similar to the pulldown menu 1035. However, pressing the button 1037 allows the user 153 to select a previously prepared image (an image stored in the terminal 151). 1039 denotes a region where a preview of the icons generated by the PWA installation processing unit 339 is displayed based on the setting values input into the fields denoted by 1031, 1033, and either 1035 or 1037.

In S919, the web application processing unit 331 accepts the setting values input by the user 153 into the fields denoted by 1031, 1033, and either 1035 or 1037. In S921, the web application processing unit 331 displays a preview of the icons in the region 1039 together with the input setting values. A button 1041 is a button that opens the installation page, that is, the RUI of the MFP 171 as illustrated in FIG. 6.

In S923, the web application processing unit 331 accepts a command in response to the user 153 pressing the button 1041. S925, S927, and S929 are processes performed in a case where the user 153 pressed the button 1037 to select a previously prepared image.

In S925, the data transmission unit 329 uploads the image selected by the user 153 to the data reception unit 361 via transmission. In S927, the data reception unit 361 stores the image received in S925 in the content storage unit 355. In S929, the data reception unit 361 returns a response to the data transmission unit 329 indicating that the image upload is successfully completed. In S931, the web application processing unit 331 generates a parameterized URL. In this case, the parameterized URL is a URL as in the following, for example, which is obtained by embedding parameters corresponding to the “name” key, “short_name” key, and “icons” key of the manifest file in the URL string of the RUI.

An example of the parameterized URL:

$$GET https : // 192.168 \text{.10} \text{.5} / portal\_top ? name = Product - AAA\_ \% E 3 \% 83 \%93 \% E 3 \%83 \% ABA 1 F \% E 5 \%8 D \%97 \% E 8 \% A 5 \% BF\_AAAAA01 \& short\_name = AAAAA 01 \& icons = \%2 Fmfp\_icon . png$$

Note that in the above-described URL example, “sizes” and “type” in the “icons” key are omitted since these “sizes” and “type” can be automatically determined on the MFP 171 side.

In S933, the content acquisition unit 325 uses the parameterized URL generated in S931 to send an acquisition request for the web content constituting the RUI to the content provision unit 357. In S935, the content provision unit 357 that has received the acquisition request for the web content commands the manifest file generation unit 369 to generate a manifest file corresponding to the parameters of the parameterized URL. The manifest file generation unit 369 then generates the manifest file by mapping values to the corresponding keys within the manifest file based on the parameters of the parameterized URL.

The following illustrates an example of the manifest file generated by the manifest file generation unit 369.

```
{
  “name”:“Product-AAA_BUILDINGA1FSOUTHWEST_AAAAA01”,
  “short_name”:“AAAAA01”,
  “start_url”:“/”,
  “lang”:“ja-jp”,
  “display”:“standalone”,
  “background_color”:“#fff”,
  “theme_color”:“#e88c31”,
  “description”:“Remote User Interface (Product-AAA)”,
  “scope”:“/”,
  “orientation”:“any”,
  “icons”:[
    {
      “src”:“/mfp_icon.png”,
      “sizes”:“512x512”,
      “type”:“image/png”
    }
  ]
}
```

In S937, the content provision unit 357 returns the web content similar to that in S515 and the manifest file generated in S935 to the content acquisition unit 325. When the process in S937 is complete, the process proceeds to S939. The processes performed in S939, S941, S943, S945, and S947 are the same as those performed in S517, S519, S521, S523, and S525, and thus the description will be omitted.

In this case, an example screen displaying icons generated through the process described using FIGS. 9 and 10 is illustrated in FIG. 11. A screen 1111 is a screen displayed on the OS display unit 311, similar to the screen 811. An icon 1131 is an icon generated in S947 by the PWA installation processing unit 339. The icon 1131 and a group of icons within a display region of the screen 1111 are not icons of similar images with similar names as in the case of the icon 831 but are icons of images with names specified by the user 153 themselves through the PWA installation URL generation page.

In this manner, by dynamically generating the manifest file using the parameterized URL, the user 153 can control the icons generated at the time of installation and can make it easier to identify the correspondence between the icons and the PWAs corresponding to the RUIs of the MFPs 171. Note that the present embodiment has described the method in which the icons of the PWAs are set through the PWA installation URL generation page. However, it is possible to achieve substantially the same effects even without using this PWA installation URL generation page. For example, a similar process can be performed by the user 153 who has prepared a parameterized URL in advance, for example, in a text editor and directly inputs the parameterized URL into the address bar of the web browser display unit 323. Thus, it is sufficient that parameters be transmitted from the terminal 151 to the MFP 171 using some method and a manifest file for installing a PWA be dynamically generated in accordance with the parameters. Thus, the method for transmitting the parameters is not limited. Furthermore, the manifest file for installing the PWA includes keys that can be set as options in addition to the “name” key, the “short_name” key, and the “icons” key mainly described in the present embodiment. These keys can also be set using the parameters of the URL.

### Second Embodiment

In the first embodiment, the method has been described in which a PWA icon with an image and a name specified by the user 153 is generated using the PWA installation URL generation page and a parameterized URL.

In contrast, instead of individual users 153 specifying the names and images of PWA icons each time, it is also possible for a user 153 with administrator privileges to configure settings related to PWA icons in advance using the RUIs of the MFPs 171, for example. In a second embodiment, a method will be described in which a user 153 with administrator privileges configures PWA icon settings for each MFP 171 in advance.

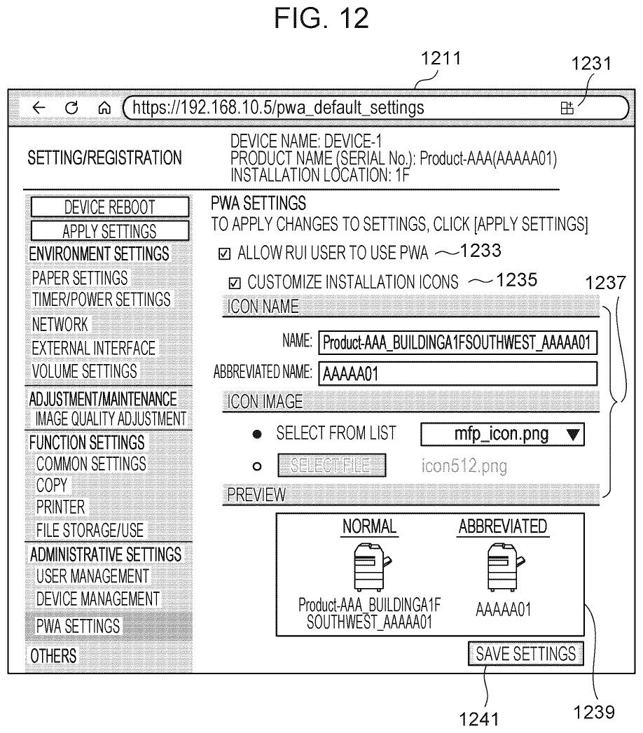

First, FIG. 12 is a diagram illustrating an example screen of an RUI provided by the MFP 171 in the second embodiment. A screen 1211 illustrates a screen of the RUI displayed on the web browser display unit 323 and displays a setting screen related to a PWA. The screen 1211 is a screen displayed in a case where the user 153 with administrative privileges has logged in to the RUI. For example, a user having an “administrator” role illustrated in Table 1 corresponds to the user with administrative privileges. A button 1231 is the same as the button 631 and is a button for installing the PWA. A check box 1233 is a check box for selecting whether or not to allow the user 153 to use the RUI of the MFP 171 as a PWA.

The first embodiment has been described assuming that the RUI of the MFP 171 is used as a PWA; however, it is also possible to restrict the user 153 from using the RUI as a PWA by using the check box 1233 to configure a setting. In a case where the check box 1233 is unchecked, that is, a setting is configured to disallow the use of the RUI as a PWA, the content provision unit 357 does not return the manifest file to the content acquisition unit 325. A check box 1235 is a box to receive a selection whether or not to customize icons generated by the PWA installation processing unit 339 at the time of PWA installation on the MFP 171 side.

The names and image of the icons are specified on the PWA installation URL generation page in the first embodiment; however, the settings for the icons can be preset on the MFP 171 side by setting the check box 1235 and a group of input fields 1237, 1239 denotes a region where a preview of icons reflecting the setting values of the group of input fields 1237 is displayed. Its description is the same as that described using FIG. 10, and thus the description will be omitted. A button 1241 is a button for saving the setting values of the check box 1233, the check box 1235, and the group of input fields 1237 to update the manifest file. When the user 153 presses the button 1241 after inputting setting values in the check box 1233, the check box 1235, and the group of input fields 1237, the manifest file update unit 371 updates the manifest file stored in the manifest file storage unit 373 based on the input setting values. The content of the manifest file is substantially the same as that described in the first embodiment, and thus the description will be omitted. Thereafter, the manifest file updated through the screen 1211 is returned to the content provision unit 357. In this manner, the user 153 with administrator privileges can configure settings related to the PWA icons in advance via the RUI of the MFP 171 to change the default manifest file to be returned by the content provision unit 357.

In this case, in a case where the check box 1235 is checked and the PWA icons are customized on the MFP 171 side, it is also possible to disable the PWA installation URL generation page (the screen 1011) described in the first embodiment. That is, it is possible to have the user 153, who uses the PWA corresponding to the RUI of the MFP 171, preferentially use the icon settings configured under administrator privileges.

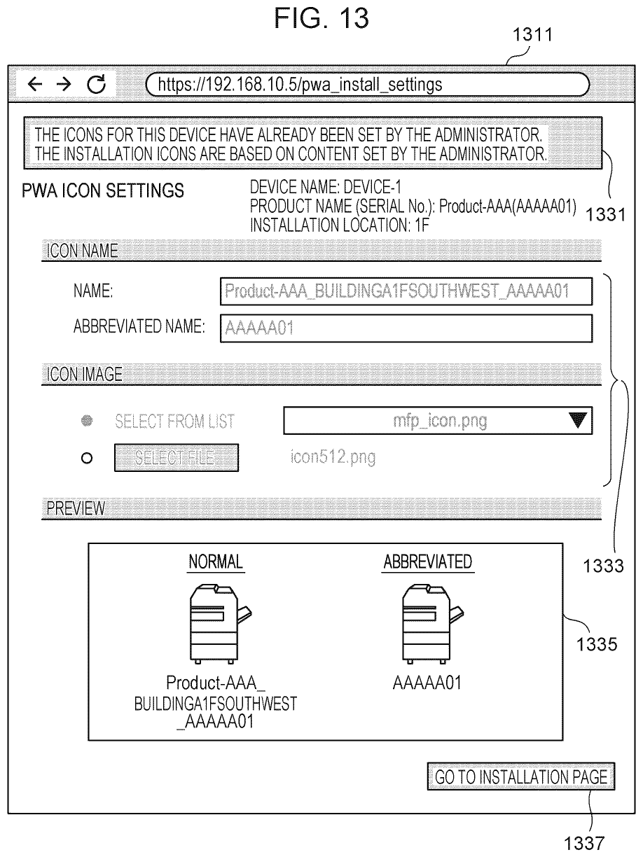

FIG. 13 is a diagram illustrating a PWA installation URL generation page, similar to FIG. 10. A screen 1311 is a screen displayed in a case where the PWA installation URL generation page is accessed in a state where the PWA icon settings have been configured through the screen 1211.

A message 1331 is displayed on the screen 1311 and indicates that the administrator has already configured the icon settings.

A group of fields 1333 is the same as the fields 1031, 1033, 1035, and 1037; however, the PWA icon settings have already been configured through the screen 1211, and the user 153 cannot input setting values. 1335 denotes a region where a preview of PWA icons is displayed, similar to the region 1039. The icons displayed in the region 1335 are icons for which settings have already been configured, that is, the same as the icons displayed in the region 1239. A button 1337 is a button that opens the same installation page as that for the button 1041, that is, the RUI of the MFP 171. On the screen 1311, the user 153 cannot set values in the group of fields 1333 but can press the button 1337. When the user 153 presses the button 1337, the screen of the RUI of the MFP 171 is opened, and an installation page similar to that illustrated on the screen 611 is displayed on the web browser display unit 323. In this case, the content provision unit 357 returns the manifest file configured under administrative privileges through the screen 1211. By performing control as described above, the content provision unit 357 can preferentially provide the MFP 171 with the manifest file for which settings have already been configured.

In the second embodiment, the method has been described in which by configuring the PWA icon settings through the screen 1211, the manifest file stored in the manifest file storage unit 373 is updated to change the default manifest file to be provided by the content provision unit 357. In contrast, it is also possible to prepare manifest files for respective sets of PWA icon setting values and switch, as necessary, the default manifest file to be provided. In that case, rather than updating and reusing a single manifest file stored in the manifest file storage unit 373, the manifest file generation unit 369 generates a manifest file for each set of setting values and stores the manifest files in the manifest file storage unit 373. Thereafter, the default manifest file to be provided by the content provision unit 357 can be switched by the user 153 with administrator privileges specifying, through the screen 1211, the set of setting values corresponding to the default manifest file the user 153 wants to provide.

In the second embodiment, the description focuses on updating the PWA icon settings from the screen 1211. However, similar to the first embodiment, it is also possible to change items other than the setting values related to the icons. This can be realized by updating the values corresponding to the respective keys within the manifest file.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-133837, filed Aug. 9, 2024, which is hereby incorporated by reference herein in its entirety.

What is claimed is:

1. A network device comprising:
a server configured to provide a user interface in response to a request from a terminal;
one or more memories storing instructions; and
one or more processors which, when executing the instructions, cause the network device to:
provide, by using the server, a setting screen for setting a parameter used to install a Progressive Web Application corresponding to the network device; and
transmit a manifest file corresponding to the parameter to a terminal to install the Progressive Web Application on the terminal.

2. The network device according to claim 1, wherein execution of the stored instructions further causes the network device to:
update the manifest file using the parameter set through the setting screen.

3. The network device according to claim 1, wherein the parameter is information related to at least one of a name and an icon image displayed at the terminal when the Progressive Web Application is installed on the terminal.

4. The network device according to claim 1, wherein the provision unit further provides information for a display for accepting an installation command for the Progressive Web Application; and
the transmission unit transmits the manifest file to the terminal in accordance with the installation command.

5. The network device according to claim 1, further comprising:
a print controller,
wherein the Progressive Web Application provides information for printing by the network device.

6. A control method for a network device equipped with a server, comprising:
providing, using the server, a setting screen for setting a parameter used to install a Progressive Web Application corresponding to the network device; and
transmitting a manifest file corresponding to the parameter to a terminal to install the Progressive Web Application on the terminal.

7. The control method according to claim 6, further comprising:
updating the manifest file using the parameter set through the setting screen.

8. The control method according to claim 6, wherein the parameter is information related to at least one of a name and an icon image displayed at the terminal in a case where the Progressive Web Application is installed on the terminal.

9. The control method according to claim 6, further comprising:
providing information for a display for accepting an installation command for the Progressive Web Application; and
transmitting the manifest file to the terminal in accordance with the installation command.

10. A non-transitory computer readable storage medium on which is stored a computer program that when executed causes a computer to execute a method implemented in a network device equipped with a server, the method comprising:
providing, using the server, a setting screen for setting a parameter used to install a Progressive Web Application corresponding to the network device; and
transmitting a manifest file corresponding to the parameter to a terminal to install the Progressive Web Application on the terminal.
